(19) United States
(12) Patent Application Publication
(10) Pub. No.: US 2019/0360456 A1
(43) Pub. Date: Nov. 28, 2019

(54) WyndBlade / New blade for Wind Turbines

(71) Applicant: Phillip Ridings, Shreewood, AR (US)

(72) Inventor: Phillip Ridings, Shreewood, AR (US)

(21) Appl. No.: 15/989,844

(22) Filed: May 25, 2018

(51) Int. Cl. F03D 1/06; F03D 80/30

(52) U.S. Cl. CPC F03D 1/0675; F03D 7/0224; F03D 1/0633; F03D 80/30

(57) ABSTRACT

This blade is a new Frame based design that produces more Energy from the wind then its Fiberglass equivalent in the same size and scale of production. Built to be modular in 40 ft sections with easy airfoil replacement this blade solves major Transportation and costly Maintenance issues, at ⅓rd the weight, when compared to conventional blades used in the industry today.

### BACKGROUND OF THE INVENTION

Problem Solved: Today's Wind Turbine Blades are made out of Heavy FiberGlass where two halves are fitted with internal spars for support over the entire length of the blade. This new design wind turbine blade eliminates the spars system uses a segmented Aerodynamic Frame as a support structure, in 40 ft sections. This frame supports the open slats that capture the wind and reduces the weight by ⅔rds when compared to the size and power ratio of an equivalent blade. “Wind Blade” increases performance factors because of its reduced weight to rotational power ratio. “Wind Blade” is built and transported in 40 ft Sections where a standard blade today are 160 ft or longer and creates major issues in form, function and transportation. Maintenance is reduced and made easier with replaceable slats after onsite visual inspections. Internal inspections are no longer needed. This design does not use internal spars to support the body instead uses replaceable slats that are much easier to inspect on this new blade design.

### BRIEF DESCRIPTION OF THE SEVERAL VIEWS OF THE DRAWING

The invention may be more readily described by reference to the accompanying drawing figures and the following description of the drawing figures. The reference numbers apply to each embodiment of the invention. In the drawing:

FIG. 1 is a side elevation view showing an embodiment of the invention with the components disassembled;

FIG. 2 is a side elevation view of FIG. 1, showing the invention assembled;

FIG. 3 is an opposite side elevation view of FIG. 2 thereof;

FIG. 4 is a perspective view of FIG. 2 thereof;

FIG. 5 is another perspective view of FIG. 2 thereof;

FIG. 6 is a side elevation view of another embodiment of the invention of FIG. 2;

FIG. 7 is a perspective view of FIG. 6 thereof;

FIG. 8 is a side elevation view of FIG. 6 thereof, showing the components disassembled;

FIG. 9 is a perspective view of another embodiment of FIG. 2 thereof;

FIG. 10 is a side elevation view of FIG. 9 thereof; and

FIG. 11 is a side elevation view of FIG. 9 thereof

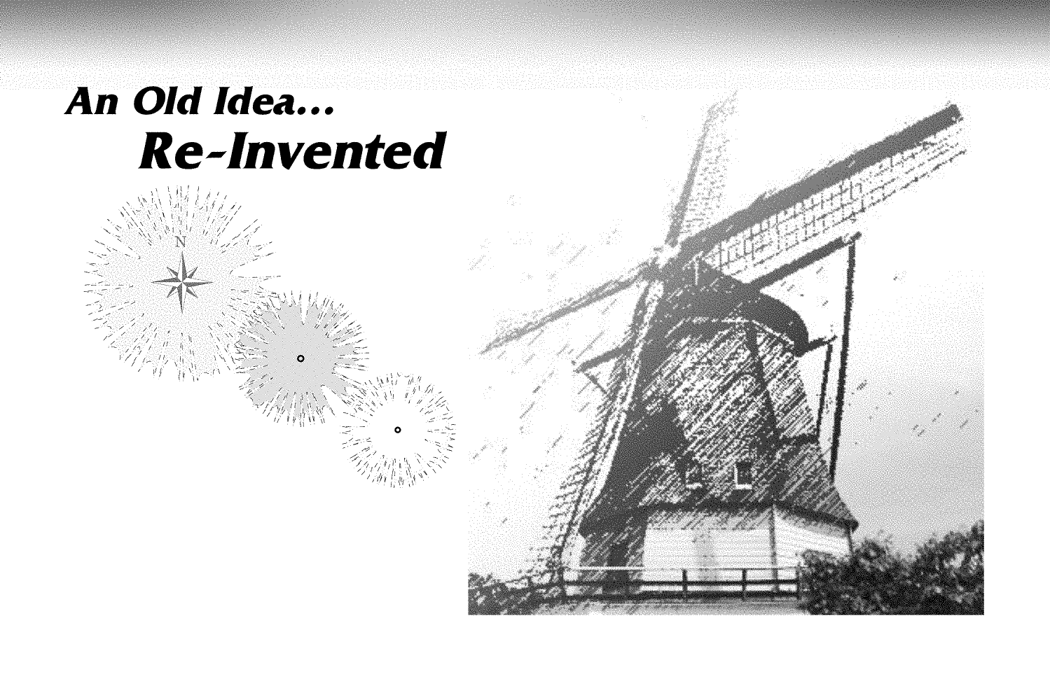

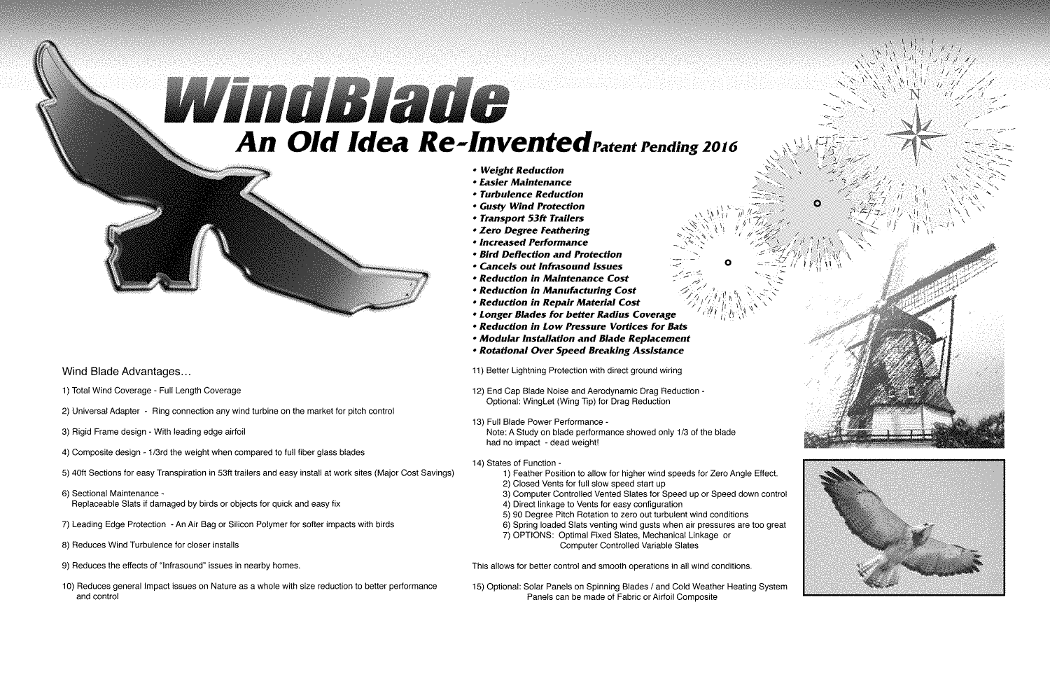

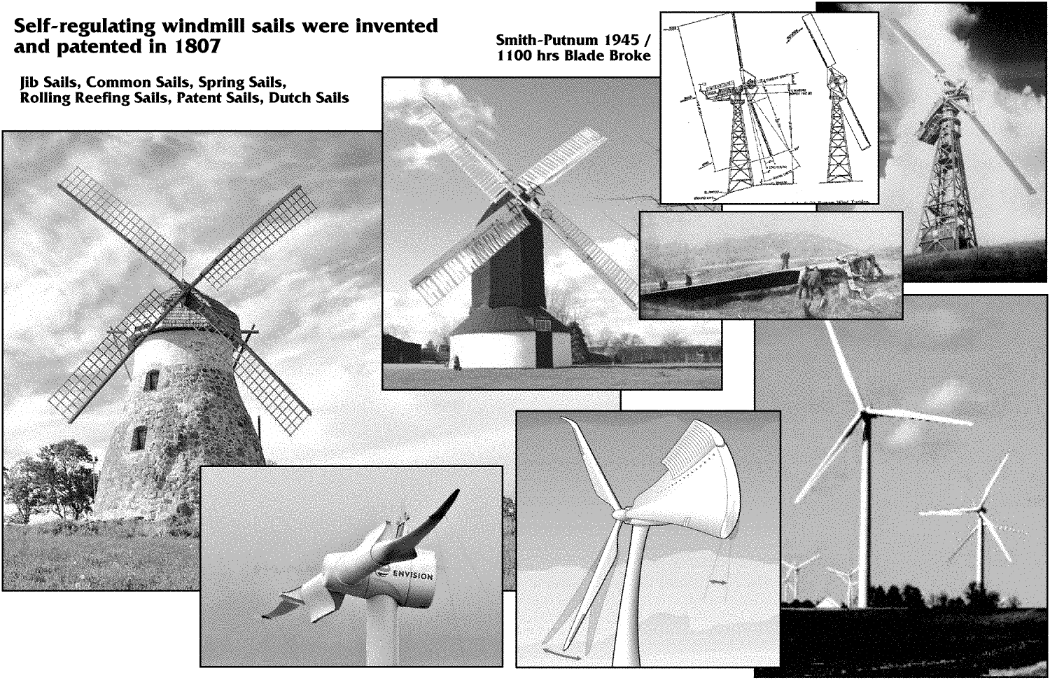

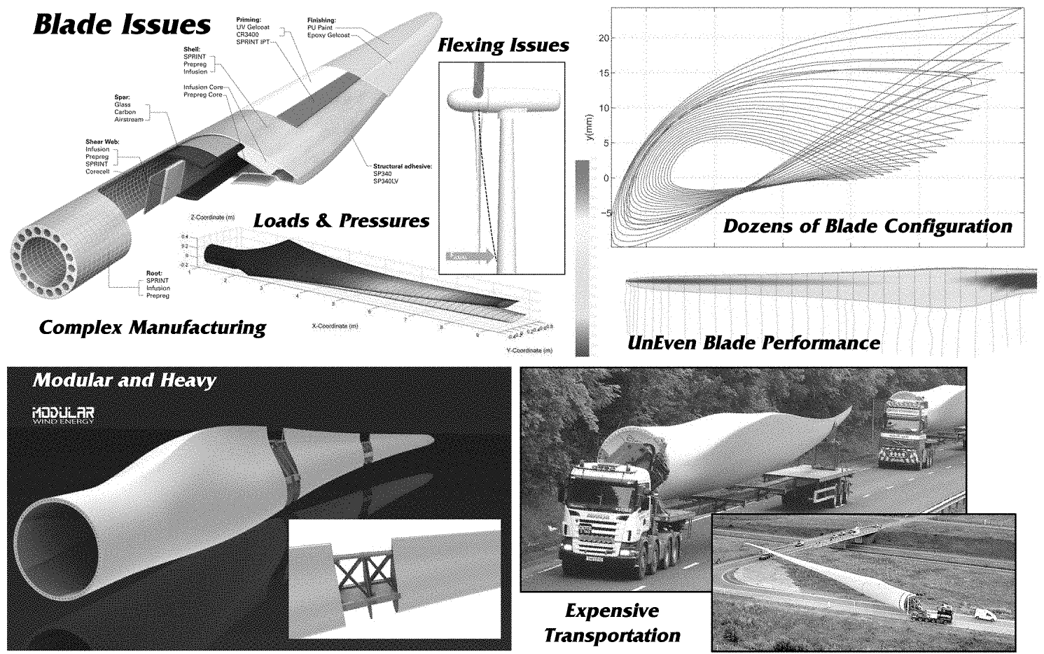

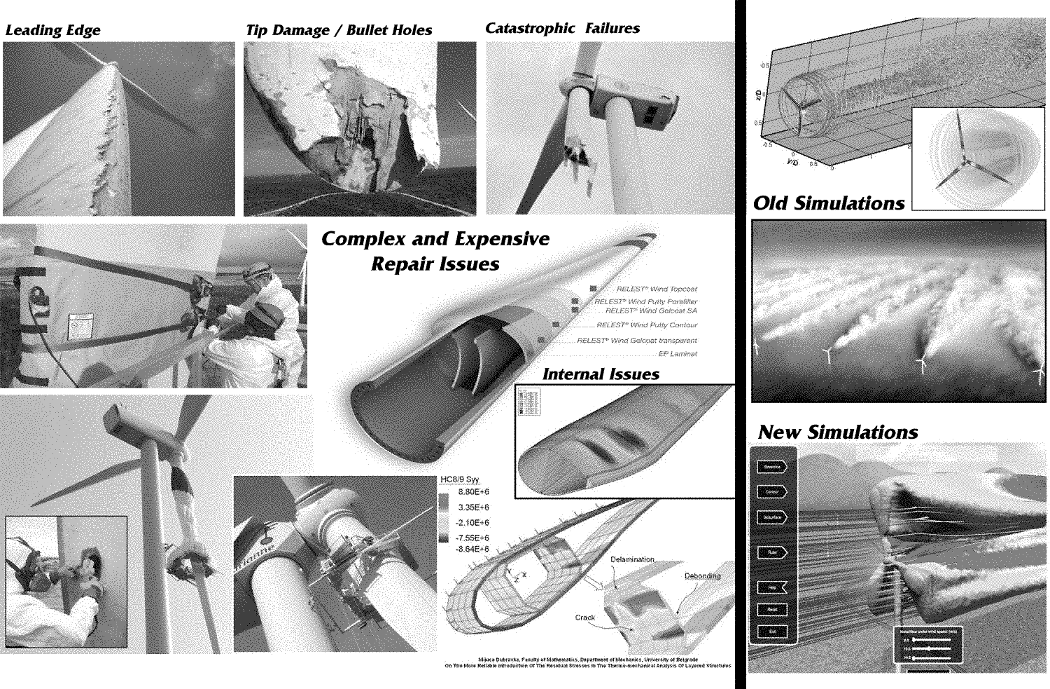

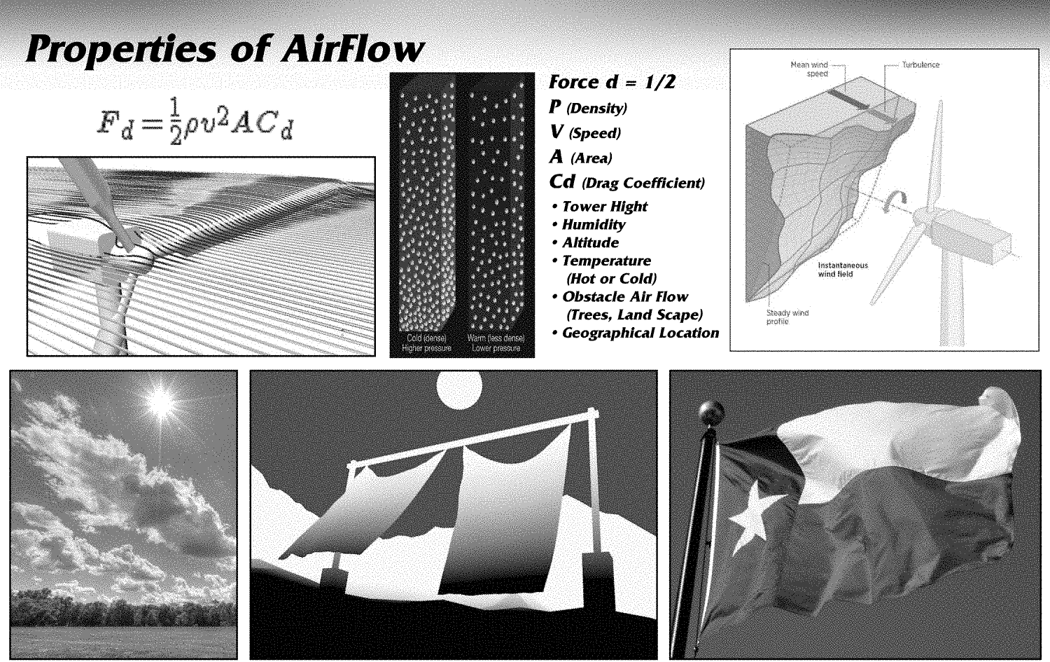

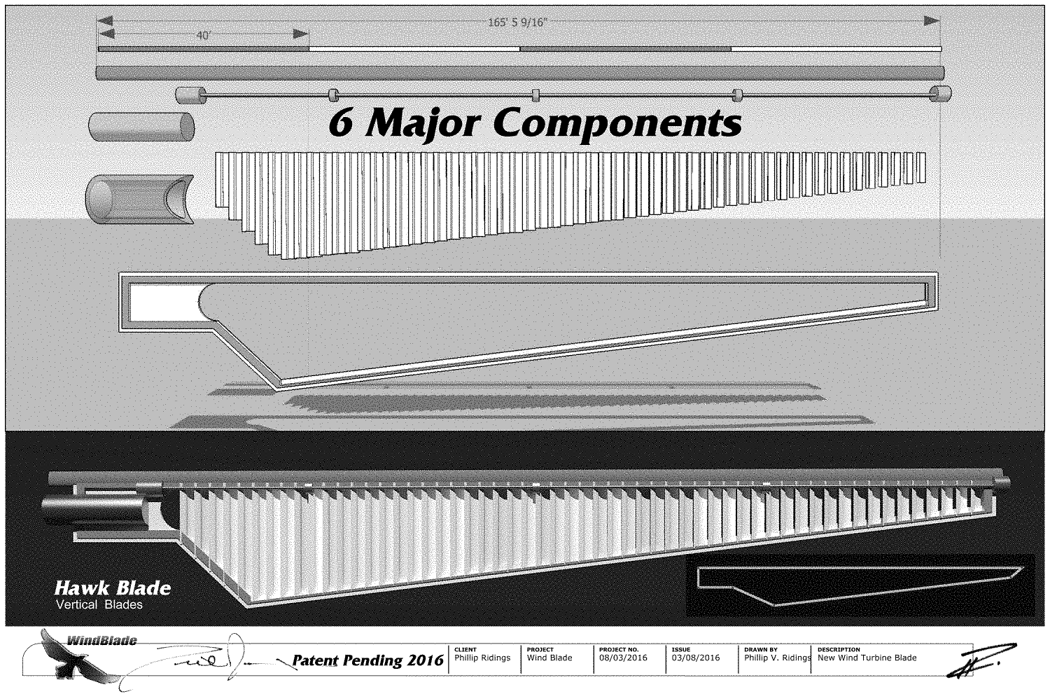

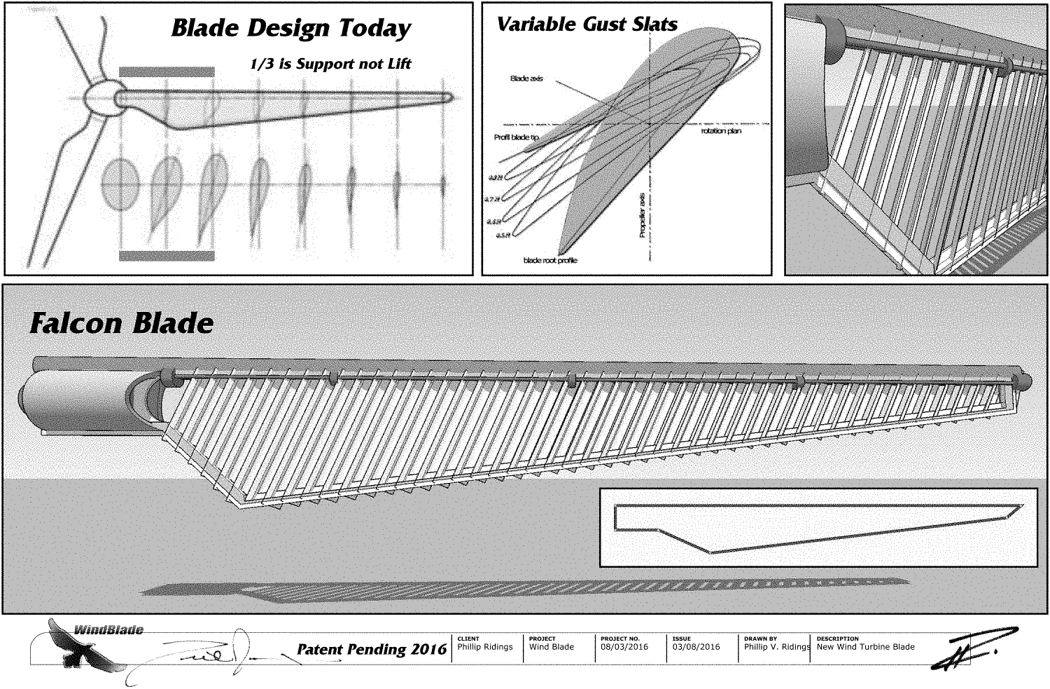

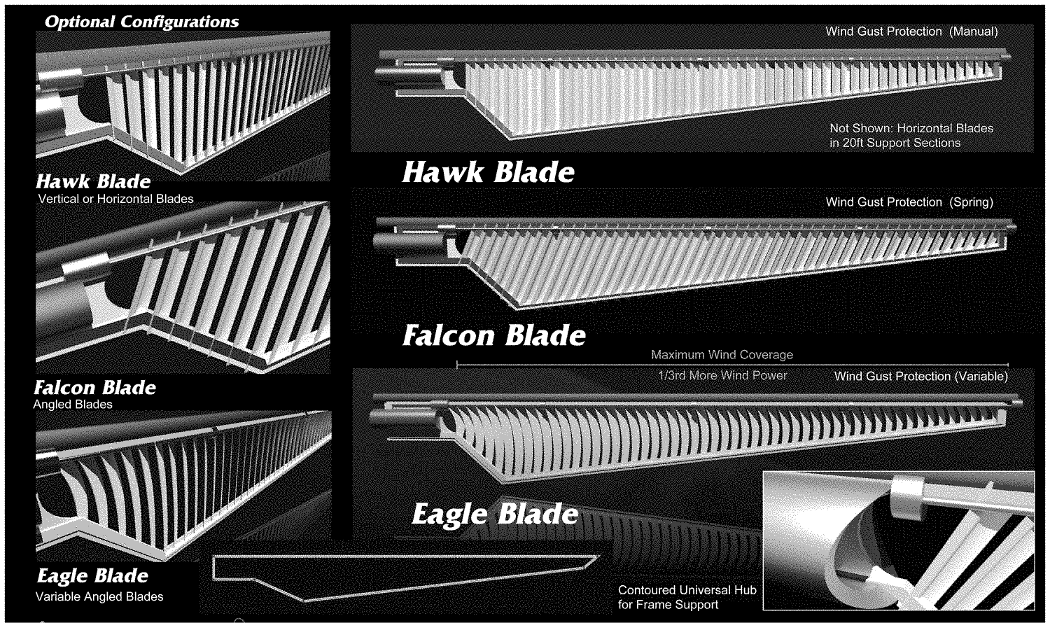

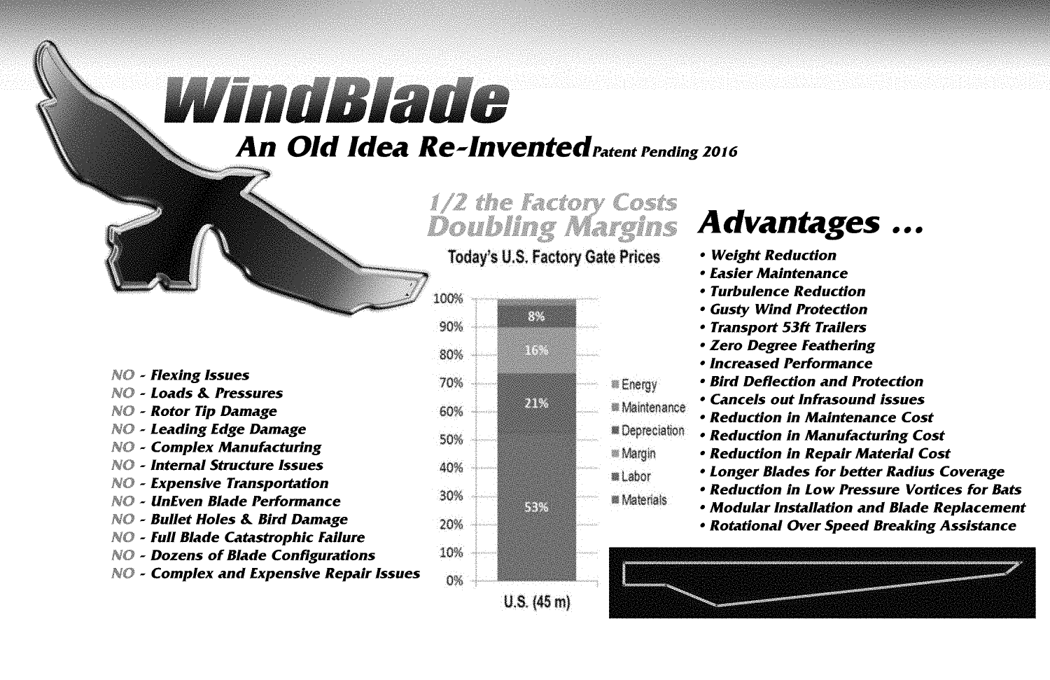

### DETAILED DESCRIPTION OF THE INVENTION

As shown in the figures, this turbine blade is a “Frame” based design. It was designed to compete with the current Fiberglass based blades used in the wind industry. The blade starts with an aerodynamic rigid frame designed to hold a number of open slats used to capture the winds energy. These slats can be in a fixed position or altered to fit the region with known air speed values. The slats can also be spring loaded for open gust protection of different air pressures or equipped with a computer controlled variable speed position for maximum performance.

The universal hub is designed to fit or retro fit any wind turbine in production today. Once the manufacturing specs are shared a custom hub can be built to fit the desired wind turbine. As this design comes in 40 ft sections, the required length of the design can be customized to fit the needs of production at ⅓rd the weight. Each 40 ft section holds a number of slats that captures the winds energy. In a recent study it was proven that only ⅔rds of the fiberglass blades overall length captures the wind power. As a result of this design we can recover the missing ⅓rd of the winds power in this simple “Frame” based design.

“Wind blade” has a few features that add to the over all performance of this design.

4) The frame itself is aerodynamic and allows air to pass over and through the leading edge of the open slats as it rotates reducing the drag over the entire system. The best description is “a knife through butter” as the pressures and drag coefficient are greatly reduced. This lower pressure redirects air through the open slat at a faster rate when compared to moving around the entire circumference of a solid fiberglass blade used today. Less Drag equals faster rotational speeds.

5) The slats that are designed to be mounted inside the frame are aerodynamic airfoils. As there are 3 different configurations each one accommodates different regions, climate and performance specs. The slats are also adjustable and or spring loaded to compensate for gusty wind conditions. 1) Straight line slat. (Hawk specs) 2) Angled Slats. (Falcon specs) 3) Curved Slats (Eagle specs)

6) The benefits of this design are Lighter, Modular, More Power to Weight Ratio. Easier to install and transport to work sites. Reduction in maintenance cost and production time losses.

The current blade systems are Not easy to Transport (added Costs). When damaged you have to replace the entire Blade at a huge cost to the company as they are heavy, bulky, not as energy efficient or productive.

Other features include a heat exchanger and a Variable pitch control on the open slats. The heat exchanger is used to melt ice that may form on the leading edge of the blade. Variable pitch slats add to the safety, speed and overall performance factors of the blade itself.

As the angle or pitch of the blade can be changed on the back side of this design Solar panels can be added. The entire length of the blade could be used to capture wind and Solar Power with new Solar based Slats.

As shown in the Figures, the Version of the Invention Discussed here Includes:

16) Total Wind Coverage—Full Length Coverage from the blade itself

17) Universal Adapter—A hub based connection that fits to the shaft of any wind turbine on the market and offers better pitch control with a “Zero Angle Effect” relative to the direction of the wind

18) Rigid Frame design that supports all the slats

19) Composite design—⅓rd the weight (or less) when compared to a fiber glass blade used today

20) 40 ft Sections for easy Transpiration in 53 ft trailers (Major Cost Savings)

21) Sectional Maintenance—Replaceable Slates if damaged by birds or objects for quick and easy fix

22) Leading Edge Protection—An Air Bag or Silicon Polymer for softer impacts with birds to increase survivability on impact.

23) Reduces Wind Turbulence for closer installs for other wind turbines. This also lowers the cost for any wind farm developer as they will not have to space them so far apart.

24) Greatly reduces the effects of “Infrasound” issues in nearby homes. (As there are two factors that contribute to this issue. 1) The current blades disrupt the air but its the houses own ducting system that amplifies the infrasound issue.

25) Reduces general Impact issues on Nature as a whole with size reduction to better performance and control

26) Better Lightning Protection on the blade tip with direct ground wiring

27) End Cap Blade Noise and Aerodynamic Drag Reduction—Optional: WingLet (Wing Tip) for Drag Reduction

28) Full Blade Power Performance—Note: A Study on blade performance showed only ⅓ of the blade had no impact—dead weight!

29) States of Function—
1) Feather Position to allow for higher wind speeds for Zero Angle Effect.
2) Closed slats in low speed winds for slow speed start up
3) Computer Controlled Vented Slates for Speed up or Speed down control
4) Direct linkage to slats for easy configuration
5) 90 Degree Pitch Rotation to zero out turbulent wind conditions
6) OPTIONS: Optimal Fixed Slates, Mechanical Linkage or Computer Controlled Variable Slates this allows for better control and smooth operations in all wind conditions.

30) Optional: Solar Panels on Spinning Blades/and Cold Weather Heating Exchange System

OPTIONS: Optimal Fixed Slates, Mechanical Linkage or Computer Controlled Variable Slates

This allows for better control and smooth operations in all wind conditions.

The primary function of this design is to harness the winds energy with this new slat based system. Secondary is how the airfoil slats work to accelerate or decelerate the speed in order to create a superior control over the speed of the rotating blades. To better control the turbulent air flow for a more consistence means of energy output. This helps reduce the spikes of energy that are a result of gusty wind conditions. The added features in this design allow more or less the airflow to effect the speed, it remains consistent. Performance values are better controlled when a consistence speed can be maintained. Control Venting allows for this unique design to function in faster wind speeds then the current wind turbines today.

The Maximum speed of the current wind turbine blade is about 55 mph. This wind blade design, with its variable speed slats allow those speeds to pass right through while maintaining a consistent rotational speed. When the speed exceeds a safe level the pitch of the entire blade can be changed or flattened out if needed to reduce damage to the blade system itself.

At the same time at a Zero angle of attack to the relative wind allows this system to become a Solar Panel System when no wind is blowing, thereby producing energy using solar power.

### Relationship Between the Components:

10) The wind turbine shaft connects to the Hub of the blade.

11) The Hub connects to the Frame as its main support structure.

12) The Frame extends in 40 ft sections to the length specified to fit the turbine and maximize its performance.

13) The Frame holds all the open airfoil slats used to capture the wind.

14) As wind passes through the open slats is causes the blade to rotate. There is less disruptive air behind the rotating blade and reduces effects of turbulent air and lowers the effects of causing any infrasound to nearby homes. (A home within 2000 ft of the turbine.)

15) The leading edge of the Frame is an airfoil used to cut through the air, reduce the enormous effects of drag over the entire system and channel the air down through the open slats.

16) The Slats are fixed, spring loaded or variable controlled via computer. This is the heart of the design as it captures the air at different angles of attack.

17) The entire pitch of the blade can be changed, at the hub, to help reduce the effects of stronger winds and reduce the effects of any weather related weather damage. Or the entire blade can be angled to increase the performance factors in relation to slower or faster wind speeds.

18) There is a lightning protection system on the tip of the spinning blade that extends into the “Frame” that supports the open slats.

### How the Invention Works:

The primary function is to harness the winds energy with this new blade design. Secondary is how the “airfoil slats” work to accelerate and/or decelerate the speed in order to create a superior control over the rotating blades. The open slat design helps to control turbulent airflow for a more consistence means of energy output. The added features in this design allow the end user to control the speed of the rotating blade by increasing or decreasing the airflow through the blade. A “Zero Angle” of attack to the relative wind allows this system to become a huge Solar panel when no wind is blowing.

3) Airflow passes through the open slats thereby forcing the blade to rotate

4) There are two addition factors that can add or decrease the speed of the rotating blade.
d) In nature of air is always turbulent it hits blades with different pressure at different speeds. The solid blade systems they use today are not built to absorb or control these pressures that can hit different parts of the blades body. On this design the angle of the open slats allows the airflow through the blades.
e) The pitch or angle or the entire blade can be rotated in relation to the winds direction. Todays blades are designed as a one piece solid body airfoil. Changing the pitch on today's blades does very little in protecting them from consistent weather conditions that create wear and tear on the external body and internal support structure that cannot be seen in a visual inspection. “Wind blade” uses slats design like little airfoils whereby a visual inspection will tell the end user if its broken and needs to be replaced. One of the side benefits is that a missing slat will not affect its production performance.

f) Using this new design means a blade can be assembled in any length needed, from 40 ft-160 ft or longer. All the components in this new design are constructed to be easily interchangeable or replaced in each 40 ft section. (Another unique feature for this Patent)

Performance values include better controlled with more consistence rotational speeds that can be maintained. Control Venting and variable pitch control allows for this unique design to function in wind speeds greater then the current wind turbine blades used today. Another fact is “Wind Blade” has a lower start up speed because of the reduced weight to power ratio.

### How to Make the Invention:

To make this invention the primary knowledge would be to know how to create airfoil systems. The Frame itself is a working airfoil. The slats may be used to capture the wind but are primarily airfoils. This entire system is designed to become the best airfoil wind turbine blade used on current and future wind turbines.

The Hub and Frame are the two key support structure for this entire design. The open airfoil slats do all the work in this design. Substructures include Hub design and mechanical connection to wind turbine rotors.

Metal and or composites used to build the Frames for structural support over the entire system.

Polymer and composite compounds used in created the form fitting slats used inside the frame.

Optional expertise includes load sensors, rational sensors, wind direction and speed controls. Pitch controls and variable spring loads to allow for gusty wind conditions and finally a heat exchange control system to keep ice from forming over the entire blade when icy conditions may warrant using it.

Based on weather conditions in the area a computer software program and onsite sensors can be used to automate this entire system.

### How to Use the Invention:

This invention is installed on the shaft of any wind turbine nacelle in the market today. This design solves major issues that other blades have to deal with. This design can be used as a New Blade system or can be Retro-fitted to fit on existing wind turbine systems.

To know how this invention is used you have to understand all the known issues that current plague the current industry.

1) Weight—This system reduces the weight by ⅔rds thereby increasing performance values

2) Size—Transportation over side roads and rural construction roads create more problems and accidents

3) Length—Transportation 160 ft blade is a major issue but this system can broken down into 40 ft sections, placed into a 53 ft standard trailer and then assembled at the work site.

4) Maintenance—Visual inspections are much easier on Wind Blade as Slats can be replaced instead of the entire blade.

5) Less prone to fail—Over time the leading eade or tip of a fiberglass blade shows signs of wear. This is a very expensive and creates an even great loss of production time. Whereas Wind Blades frame just has to be replaced and not the entire blade, reducing the loss of production time.

6) Flexing—One of the know dangers is when a blade is too long it tends to flex with greater wind pressures. This flexing accuses at the tip of the blade and when it flexes too much it impacts on the support pole. This new blade design is a rigged rotor. The frame based system reduces excessive flexing which in turn allows for a longer blade. Longer blades means more power as the rotational area coverage is increased thereby capturing more of the wind energy.

7) Please not the PDF included has a list of other advantages to this new design not mentioned here.

I claim:

1. A wind turbine blade comprising:
a. a hub comprising a distal portion of the hub being removably connectable to a pre-existing shaft of a wind turbine nacelle, and a proximal portion of the hub being connectable to a frame of the wind turbine blade; and
b. the frame of the wind turbine blade having an aerodynamic modular body, with the frame supporting a plurality of airfoil slats for capturing wind energy to facilitate rotating the wind turbine blade when installed on the wind turbine nacelle, with each of the plurality of airfoil slats having a leading each, with each of the plurality of airfoil slats being removably mountable inside the frame in an open position
c. wherein the installed wind turbine blade being actuated and rotatable about the hub connection to the wind turbine nacelle when airflow passes over and through the leading edge of each of the plurality of airfoil slats when in an open position;
d. wherein the plurality of airfoil slats being selectively operable to accelerate or decelerate the rotational speed of the wind turbine blade for maintaining consistent rotational speed.

2. The wind turbine blade of claim 1, each of the plurality of airfoil slats comprising a vertical orientation within the frame of the wind turbine blade.

3. The wind turbine blade of claim 1, each of the plurality of airfoil slats comprising an angled orientation within the frame of the wind turbine blade.

4. The wind turbine blade of claim 1, each of the plurality of airfoil slats comprising a curved orientation within the frame of the wind turbine blade.

5. The wind turbine blade of claim 1, the plurality of airfoil slats being selectively actuated in an open position or a closed position, with the actuation means being selected from the group consisting of mechanical actuation, electronic actuation, or fixed, and combinations thereof.

6. The wind turbine blade of claim 1, the frame of the wind turbine blade further comprising a non-rigid edge protector for increasing bird survival upon impact.

7. The wind turbine blade of claim 1, the wind turbine blade further comprising a ground wire for lightening protection.
